(19) United States
(12) Patent Application Publication
(10) Pub. No.: US 2025/0280090 A1
(43) Pub. Date: Sep. 4, 2025

(54) IMAGE READER, MULTI-FUNCTION PERIPHERAL, AND METHOD FOR PERFORMING ERROR NOTIFICATION AT APPROPRIATE TIME IN RESPONSE TO OCCURRENCE OF ERROR DURING USE OF READING UNIT

(71) Applicant: BROTHER KOGYO KABUSHIKI KAISHA, Nagoya (JP)

(72) Inventors: Yuto INAYOSHI, Okazaki (JP); Taiga MIZUMORI, Nagoya (JP)

(21) Appl. No.: 19/058,689

(22) Filed: Feb. 20, 2025

(30) Foreign Application Priority Data
Feb. 29, 2024 (JP) 2024-029862

(51) Int. Cl. H04N 1/32; H04N 1/10

(52) U.S. Cl. CPC H04N 1/3263; H04N 1/1061

(57) ABSTRACT

An image reader includes a transparent plate having a placement surface configured to support a read target object placed thereon, a reading unit including a light source configured to emit light toward the transparent plate, and a controller. The controller is configured to perform a reading process to cause the reading unit to read the read target object placed on the placement surface of the transparent plate. The controller is further configured to, in response to occurrence of an error, perform an error notification process to cause the reading unit to perform an error notification operation. The controller is further configured to, depending on one or more occurrence conditions for the error that has occurred while the reading unit is in use, determine whether to perform the error notification process by interrupting the use of the reading unit or after the use of the reading unit is completed.

### REFERENCE TO RELATED APPLICATIONS

This application claims priority from Japanese Patent Application No. 2024-029862 filed on Feb. 29, 2024. The entire content of the priority application is incorporated herein by reference.

### BACKGROUND ART

Heretofore, image readers have been known that are configured to optically read an object to be read (hereinafter, which may be referred to as a “read target object”).

An image reader, as an example of the known image readers, includes a reading unit disposed below a transparent plate. The reading unit includes a light source and an image sensor. The image sensor includes a plurality of light receiving elements arranged along a main scanning direction. When light emitted from the light source of the reading unit is reflected by a read target object placed on the transparent plate, and the reflected light is incident on the image sensor of the reading unit, photoelectric conversion is performed by each light receiving element. Thus, a reading operation for a single line along the main scanning direction is achieved by the reading unit. By repeatedly performing the reading operation for a single line along the main scanning direction while moving the reading unit in a sub scanning direction orthogonal to the main scanning direction, the image reader reads the entire read target object, thereby generating image data of the read target object.

Some of the known image readers include a display such as an LCD (“LCD” is an abbreviation for “Liquid Crystal Display”), while others do not include such a display. The image reader with a display is enabled to, when an error that prevents the image reader from operating normally has occurred in the image reader, cause the display to display that the image reader is in an error state, thereby notifying a user of the error state until the error is resolved. However, the image reader without a display is unable to cause the display to display that the image reader is in an error state even if an error occurs.

Therefore, a technology has been proposed in which, when an image reader without a display is brought into an error state, the image reader notifies a user of the error state by moving a reading unit to a specific position and turning on a light source with the reading unit stopped at the specific position.

### SUMMARY

However, in the known technology, if an error occurs while the image reader is performing a reading process to cause the reading unit to read a read target object, it is not clear when an error notification process to provide a notification that the image reader is in an error state is to be performed. In addition, if another error occurs while the notification that the image reader is in the error state is being provided, it is not clear when an error notification process to provide a notification that the image reader is in an error state due to said another error is to be performed.

Aspects of the present disclosure are advantageous for providing one or more improved techniques that make it possible to perform an error notification process at an appropriate time in response to the occurrence of an error during the use of a reading unit (e.g., while the image reader is performing a reading process or providing a notification that the image reader is in an error state).

According to aspects of the present disclosure, an image reader is provided, which includes a transparent plate, a reading unit, and a controller. The transparent plate has a placement surface configured to support a read target object placed thereon. The reading unit includes a light source configured to emit light toward the transparent plate. The controller is configured to perform a reading process to cause the reading unit to read the read target object placed on the placement surface of the transparent plate. The controller is further configured to, in response to occurrence of an error, perform an error notification process to cause the reading unit to perform an error notification operation. The controller is further configured to, depending on one or more occurrence conditions for the error that has occurred while the reading unit is in use, determine whether to perform the error notification process by interrupting the use of the reading unit or after the use of the reading unit is completed.

According to aspects of the present disclosure, further provided is a multi-function peripheral that includes an image reader, a printer, and a controller. The printer is configured to print an image on a printing medium. The image reader is configured to read a read target object. The image reader includes a transparent plate and a reading unit. The transparent plate has a placement surface configured to support the read target object placed thereon. The reading unit includes a light source configured to emit light toward the transparent plate. The controller is configured to perform a reading process to cause the reading unit to read the read target object placed on the placement surface of the transparent plate. The controller is further configured to, in response to occurrence of an error, perform an error notification process to cause the reading unit to perform an error notification operation. The controller is further configured to, depending on one or more occurrence conditions for the error that has occurred while the reading unit is in use, determine whether to perform the error notification process by interrupting the use of the reading unit or after the use of the reading unit is completed.

According to aspects of the present disclosure, further provided is a method implementable on a processor of an image reader. The image reader includes a transparent plate and a reading unit. The method includes performing a reading process to cause the reading unit to read a read target object placed on a placement surface of the transparent plate. The method further includes performing, in response to occurrence of an error, an error notification process to cause the reading unit to perform an error notification operation. The method further includes determining, depending on one or more occurrence conditions for the error that has occurred while the reading unit is in use, whether to perform the error notification process by interrupting the use of the reading unit or after the use of the reading unit is completed.

### BRIEF DESCRIPTION OF DRAWINGS

FIG. 1 is a perspective view showing a multi-function peripheral (hereinafter referred to as an “MFP”).

FIG. 2 is a cross-sectional view illustrating an internal configuration of an image reader.

FIG. 3 schematically shows a reading unit and a part of a downward-facing surface of a top plate of a housing of the image reader.

FIG. 4 shows examples of a reference position, a standby position, a reading start position, a reading end position, and error notification position(s).

FIG. 5 is a cross-sectional view illustrating an internal configuration of a printer.

FIG. 6 is a block diagram showing an electrical configuration of the MFP.

FIGS. 7A and 7B are flowcharts showing an example procedure of an error notification timing determination process.

FIGS. 8A and 8B are flowcharts showing another example procedure of the error notification timing determination process.

FIGS. 9A and 9B show examples in which a first position condition is satisfied.

FIGS. 10A and 10B show examples in which a second position condition is satisfied.

FIG. 11 shows an example in which none of the first position condition and the second position condition is satisfied.

### DESCRIPTION

It is noted that various connections are set forth between elements in the following description. It is noted that these connections in general and, unless specified otherwise, may be direct or indirect and that this specification is not intended to be limiting in this respect. Aspects of the present disclosure may be implemented on circuits (such as application specific integrated circuits) or in computer software as programs storable on computer-readable media including but not limited to RAMs, ROMs, flash memories, EEPROMs, CD-media, DVD-media, temporary storage, hard disk drives, floppy drives, permanent storage, and the like.

In the present disclosure, an inclusive OR, meaning that it includes either A or B or both, may be expressed as “A and/or B,” “at least one of A or B,” or “at least one selected from the group consisting of A and B.” The same applies to a case where there are three or more selectable elements to consider.

A detailed explanation will be provided below of an illustrative embodiment according to aspects of the present disclosure with reference to the accompanying drawings.

### Multi-Function Peripheral

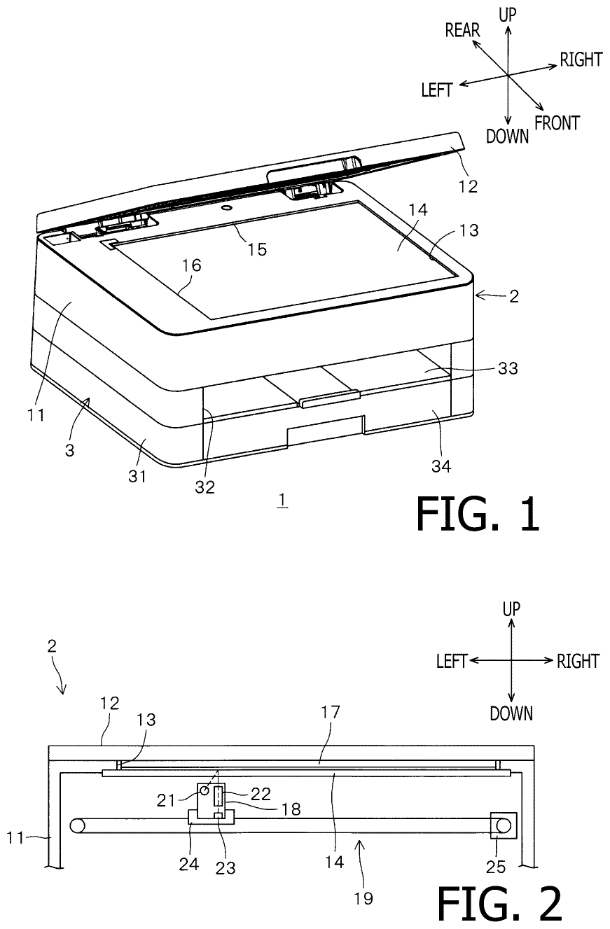

A multi-function peripheral (hereinafter referred to as an “MFP”) 1 shown in FIG. 1 includes an image reader 2 configured to read an object to be read (hereinafter, which may be referred to as a “read target object”), and a printer 3 configured to print an image according to image data on a sheet-like medium. Examples of the read target object may include, but are not limited to, originals such as text or photographs to be read for reproduction by printing, documents to be read for electronic documentation by OCR (“OCR” is an abbreviation for “Optical Character Recognition”) technology, and sheets on which bar codes (one-dimensional bar codes and two-dimensional codes) to be read for decoding are displayed.

In the illustrative embodiment, a frontward direction, a rearward direction, an upward direction, a downward direction, a leftward direction, and a rightward direction of the MFP 1 are defined as shown in FIGS. 1, 2, 3, and 5, and these directions are used as appropriate in the following description.

### Image Reader

As shown in FIGS. 1 and 2, the image reader 2 includes a housing 11 formed substantially in a rectangular shape, and a cover 12 configured to open and close an upper side of the housing 11. A rear end portion of the cover 12 is connected with an upper rear end portion of the housing 11 in such a manner as to be swingable around an axis extending along left-right directions (i.e., the leftward direction and the rightward direction). The cover 12 is configured to swing between an open position and a closed position. Specifically, when the cover 12 is in the open position, a front end of the cover 12 is lifted relative to the upper side of the housing 11 in such a manner as to open the upper side of the housing 11. Meanwhile, when the cover 12 is in the closed position, the cover 12 lies down on the upper side of the housing 11 in such a manner as to cover and close the upper side of the housing 11.

The housing 11 has a rectangular opening 13 formed in an upper surface of the housing 11 to be long in the left-right directions. The opening 13 is closed from below by a transparent plate 14. The transparent plate 14 is made of a transparent plate such as a transparent glass plate or a transparent resin plate.

The read target object is placed at a particular position on the transparent plate 14 with a target surface of the read target object facing downward. The particular position is a position defined based on a left rear corner where a rear edge 15 and a left edge 16 of the opening 13 intersect each other. For instance, when the read target object is formed in a rectangular shape, a corner of the read target object is brought into precise positional adjustment relative to the left rear corner of the opening 13 in such a manner that two edges of the read target object come into contact with the rear edge 15 and the left edge 16 of the opening 13.

As shown in FIG. 2, a background member 17 made of a white resin sheet is elastically supported on an inner surface of the cover 12. The background member 17 is formed substantially in a rectangular shape with a size smaller than the opening 13. When the cover 12 is moved from the open position to the closed position after the read target object is placed on the transparent plate 14, the background member 17 does not ride up on a periphery of the opening 13 of the housing 11, but is placed inside the opening 13 to be spaced apart from each edge of the opening 13, thereby pressing the read target object against the transparent plate 14.

A reading unit 18 and a moving mechanism 19 are disposed below the transparent plate 14.

The reading unit 18 is configured as a CIS (“CIS” is an abbreviation for “Contact Image Sensor”) unit. The reading unit 18 includes a light source 21, a rod lens array 22, and an image sensor 23. The light source 21 includes LEDs (“LED” is an abbreviation for “Light Emitting Diode”) for three colors of R (red), G (green) and B (blue). The rod lens array 22 includes a plurality of rod lenses aligned along a main scanning direction. The main scanning direction is parallel to front-rear directions (i.e., the frontward direction and the rearward direction). Each rod lens is a refractive index distribution lens with upright equal magnification. The image sensor 23 is a linear image sensor including a plurality of light receiving elements arranged at regular intervals of a particular distance along the main scanning direction. For instance, each light receiving element includes color filters and photodiodes for the three colors of R (red), G (green), and B (blue). Each light receiving element is configured to receive light and output an electrical signal (voltage) corresponding to an intensity of each of the RGB color components contained in the received light.

The moving mechanism 19 is configured to move the reading unit 18 along sub scanning directions orthogonal to the main scanning direction. The sub-scanning directions are identical to the left-right directions. The moving mechanism 19 includes a CIS carriage 24 carrying the reading unit 18, and a scanner motor 25 configured to generate a driving force to reciprocate the CIS carriage 24 along the left-right directions.

Example configurations for the image reader 2 are not limited to a configuration in which a CIS system that is an equal magnification optical system is employed as a reading system, but may include a configuration in which a reduction optical system, i.e., a CCD (“CCD” is an abbreviation for “Charge Coupled Devices”) system is employed.

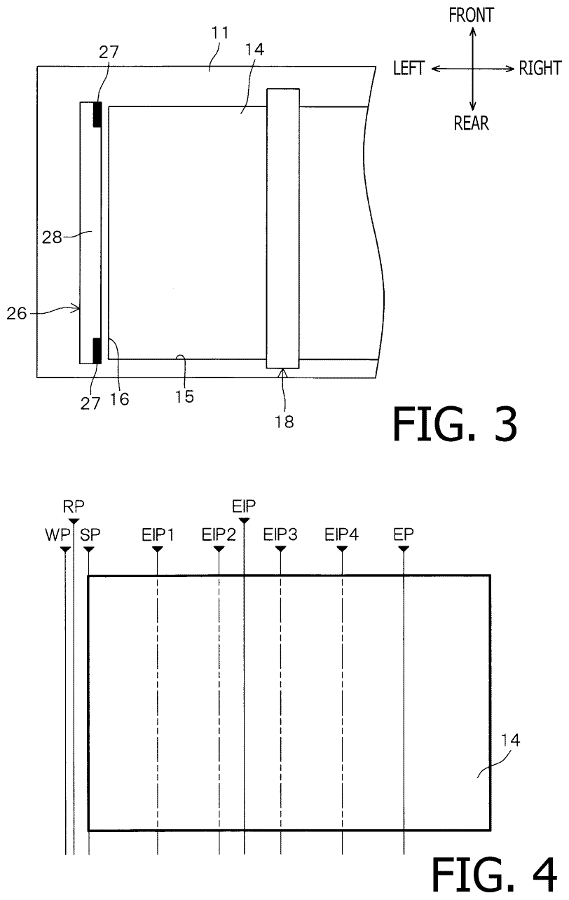

As shown in FIG. 3, a reference member 26 made of a rectangular tape is disposed to the left of the transparent plate 14. The reference member 26 is attached to a downward-facing surface of a top plate of the housing 11 in such a manner as to extend along the front-rear directions on the left side of the transparent plate 14. The reference member 26 includes black areas 27, which are rectangular areas in a front right corner and a rear right corner of the reference member 26, and a white area 28, which is a remaining area other than the black areas 27. As a result, at an end portion along a right edge of the reference member 26, the white area 28 is sandwiched between the two black areas 27 in the front-rear directions, and the black areas 27 and the white area 28 are continuous in the front-rear directions. At each of an end portion along a front edge of the reference member 26 and another end portion along a rear edge of the reference member 26, the white area 28 is adjacent to a left end of the corresponding black area 27, and the corresponding black area 27 and the white area 28 are continuous in the left-right directions.

As shown in FIG. 4, the position of a boundary between a black area 27 and the white area 28, which are continuous in the left-right directions, is a reference position RP. For the image reader 2, specific positions, each of which is a start point or an end point of the movement of the reading unit 18, are set based on the reference position RP. The specific positions, each of which is a start point or an end point of the movement of the reading unit 18, include a standby position WP, a reading start position SP, and a reading end position EP. The standby position WP is a position at which the reading unit 18 is placed when the reading unit 18 is in a standby state in which the reading unit 18 is not in operation. The standby position WP is set spaced leftward from the left edge 16 of the opening 13. The reading start position SP is set spaced leftward from the left edge 16 of the opening 13. The reading end position EP is a position set according to the size of the read target object. The reading end position EP is set spaced rightward from the reading start position SP by a distance according to a length of the read target object in the sub scanning directions.

The standby position WP may be the same as the reference position RP. The reading start position SP may be set spaced rightward from the left edge 16 of the opening 13 by a particular reading margin in order to prevent the reading unit 18 from reading the downward-facing surface of the top plate of the housing 11. A position of the reading unit 18 represents a position of the reading unit 18 when light reflected from the reference member 26, the read target object that is on the transparent plate 14, or the background member 17 is incident on the image sensor 23 of the reading unit 18. For instance, when the light reflected from the read target object that is in the reading end position EP is incident on the image sensor 23, the position of the reading unit 18 coincides with the reading end position EP.

### Printer

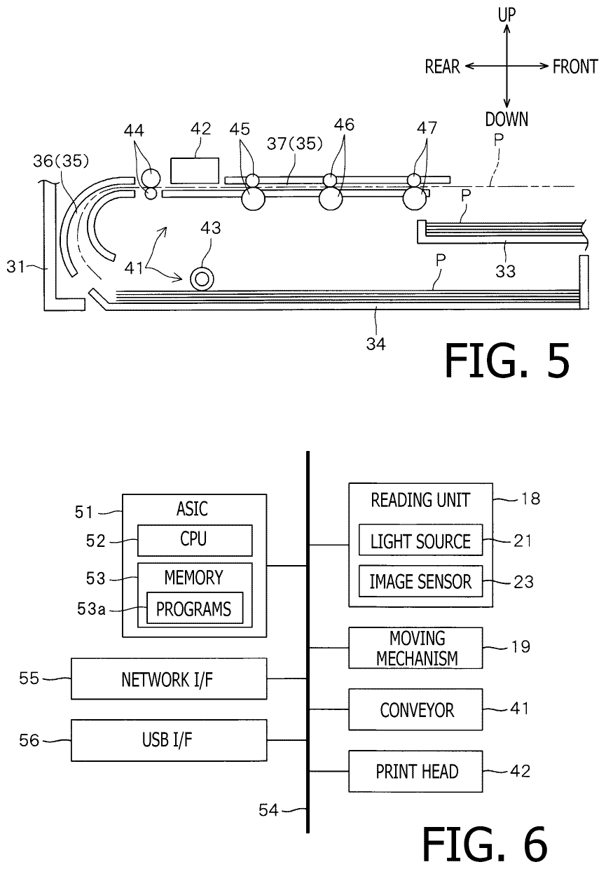

As shown in FIG. 1, the printer 3 includes a housing 31. A rectangular opening 32 is formed in a front surface of the housing 31. The printer 3 further includes a plate-shaped discharge tray 33 in the housing 31. The discharge tray 33 extends along the front-rear directions and the left-right directions to divide a space behind the opening 32 into two sections, i.e., an upper space and a lower space. The printer 3 further includes a feed tray 34 disposed in the lower space below the discharge tray 33. The feed tray 34 is configured to be inserted and removed through the opening 32. The feed tray 34 is formed in a box shape with an open top. For instance, as shown in FIG. 5, printing sheets P are stored in a stacked state on the feed tray 34. The printing sheets P may be an example of “print media” according to aspects of the present disclosure. A printing sheet P with an image printed thereon is discharged into the upper space above the discharge tray 33.

A conveyance path 35 along which the printing sheets P are conveyed is formed in the housing 31. The conveyance path 35 includes a curved path 36 and a straight path 36. The curved path 36 is formed substantially in a semicircular arc shape that curves upward while inflated backward from a rear end of the feed tray 34. The straight path 37 extends straight forward from the curved path 36.

The printer 3 further includes a conveyor 41 and a print head 42 in the housing 31.

The conveyor 41 is configured to convey print media along the conveyance path 35. The conveyor 41 includes a pickup roller 43, first conveyance rollers 44, second conveyance rollers 45, third conveyance rollers 46, and discharge rollers 47. The conveyor 41 further includes a conveyance motor (not shown) configured to provide a driving force to the pickup roller 43, the first conveyance rollers 44, the second conveyance rollers 45, the third conveyance rollers 46, and the discharge rollers 47.

The pickup roller 43 is disposed at such a position that a circumferential surface thereof comes into contact with a topmost one of the printing sheets P in the feed tray 34 when the feed tray 34 is inserted into the lower space below the discharge tray 33. The first conveyance rollers 44 are disposed at a rear end portion of the straight path 37. The second conveyance rollers 45 are spaced forward from the first conveyance rollers 44. The third conveyance rollers 46 are spaced forward from the second conveyance rollers 45. The discharge rollers 47 are spaced forward from the third conveyance rollers 46 and disposed at a front end portion of the straight path 37.

The print head 42 is disposed between the first conveyance rollers 44 and the second conveyance rollers 45 and above the conveyance path 35. A plurality of nozzles are arranged in a lower surface (i.e., a downward-facing surface) of the print head 42. When ink is ejected from the nozzles of the print head 42 with the print head 42 facing a printing sheet P, ink droplets land on the printing sheet P.

The print head 42 may be a line head of which a position is fixed in the main scanning direction, or may be a serial head configured to reciprocate along the main scanning direction, which is parallel to the front-rear directions.

Practicable examples of the printer 3 are not limited to a configuration employing an inkjet method as a printing method, but may include a configuration employing an electrophotographic method or a thermal method.

### Electrical Configuration

As shown in FIG. 6, the MFP 1 includes an ASIC (“ASIC” is an abbreviation for “Application Specific Integrated Circuit”) 51. The ASIC 51 incorporates a CPU (“CPU” is an abbreviation for “Central Processing Unit”) 52 and a memory 53. The memory 53 is a memory unit that includes a non-volatile memory configured to rewrite data, such as a flash memory or an EEPROM (“EEPROM” is an abbreviation for “Electrically Erasable Programmable Read-Only Memory”), and a volatile memory such as a DRAM (“DRAM” is an abbreviation for “Dynamic Random Access Memory”).

The ASIC 51 is connected with a bus 54 for data communication. The bus 54 is connected with the reading unit 18 and the moving mechanism 19 of the image reader 2, and with the conveyor 41 and the print head 42 of the printer 3.

The MFP 1 further includes a network I/F (“I/F” is an abbreviation for “interface”) 55 and a USB I/F 56. The network I/F 55 and the USB I/F 56 are connected with the bus 54.

The network I/F 55 is an interface for data communication (network communication) with external devices via a network. Examples of the external devices communicable with the MFP 1 via the network I/F 55 may include, but are not limited to, a PC (“PC” is an abbreviation for “Personal Computer”) and an FTP (“FTP” is an abbreviation for “File Transfer Protocol”) server. The network communication method may be a wireless communication method or a wired communication method.

The USB I/F 56 is an interface for data communication with USB devices such as a USB memory. The USB I/F 56 includes a USB connector to which a USB cable is connected, and a USB controller configured to control a USB connection with a USB device.

The CPU 52 of the ASIC 51 is configured to execute programs 53a stored in the non-volatile memory of the memory 53, thereby controlling operations of the image reader 2 (including the reading unit 18 and the moving mechanism 19). The CPU 52 is further configured to execute programs 53a stored in the non-volatile memory of the memory 53, thereby controlling operations of the printer 3 (including the conveyor 41 and the print head 42). When executing those programs 53a, the CPU 52 uses the volatile memory of the memory 53 as a work area.

### Reading Process

In the MFP 1, the CPU 52 performs a reading process to cause the image reader 2 to read the read target object. To start the reading process, the user places the read target object at a specified position on the transparent plate 14, and thereafter operates operable key(s) provided on an external device or on the MFP 1 to provide an instruction to start the reading process. In response to the user operation on the operable key(s), the instruction to start the reading process is input into the CPU 52. In response to receiving the instruction to start the reading process, the CPU 52 starts the reading process.

In the reading process, the CPU 52 performs a reading operation and a return operation.

In the reading operation, the CPU 52 turns on the light source 21 of the reading unit 18, and moves the reading unit 18 at a constant speed in one direction (e.g., the rightward direction) of the sub scanning directions, from the reading start position SP to the reading end position EP.

In the reading operation, light emitted from the light source 21 is transmitted through the transparent plate 14 and reflected by the read target object on the transparent plate 14 or by the background member 17, and the reflected light is transmitted through the transparent plate 14 again. When the reflected light passes through the rod lens array 22 to be incident on the image sensor 23, photoelectric conversion is performed at each light receiving element of the image sensor 23. Thereby, a voltage (an electrical signal) corresponding to an amount of light received is output from each light receiving element.

The ASIC 51 includes an A/D conversion circuit. For instance, the A/D conversion circuit has a resolution of 8 bits (256 levels from 0 to 255), and is configured to convert the voltages (the electrical signals) output from the image sensor 23 into pixel values (image data), which are digital values, for each color of RGB. For instance, voltages lower than a lower reference voltage (i.e., a lower limit) are uniformly converted into the pixel value “0.” Voltages higher than an upper reference voltage (i.e., an upper limit) are uniformly converted into the pixel value “255.” Voltages within a range from the lower limit to the upper limit are converted into respective pixel values according to how high each voltage is. When the voltage output from each light receiving element is converted into a corresponding pixel value, reading of a single line in the main scanning direction by the reading unit 18 is accomplished.

In the reading operation, the CPU 52 causes the reading unit 18 to repeatedly perform the single-line reading while moving the reading unit 18 at a constant speed from the reading start position SP to the reading end position EP, thereby reading a reading range between the reading start position SP and the reading end position EP to generate image data of the read target object. When the reading unit 18 has reached the reading end position EP, the reading operation is completed.

After the reading operation is completed, the CPU 52 starts the return operation. In the return operation, the CPU 52 reverses the moving direction of the reading unit 18 and moves the reading unit 18 in the other direction (i.e., in the leftward direction) of the sub scanning directions toward the standby position WP.

During the return operation, the CPU 52 causes the reading unit 18 to read the reference member 26. Then, from the image data generated by reading the reference member 26, the CPU 52 searches for a particular position where the pixel value changes from one value to another across a black-white determination threshold between mutually adjacent pixels in the sub scanning directions. When the particular position is found, the CPU 52 determines the particular position as the reference position RP (detection of the reference position RP). In addition, the CPU 52 sets the standby position WP and the reading start position SP based on the reference position RP. When the reading unit 18 is stopped at the standby position WP, the return operation is completed.

During the reading process, after generating the image data of the read target object, the CPU 52 performs a data transmission operation to transmit the generated image data to an external device via the network I/F 55, or a data storage operation to store the generated image data in a USB memory via the USB I/F 56. Examples of the data transmission operation may include, but are not limited to, transmitting the image data of the read target object to a PC, transmitting the image data of the read target object to an FTP server, and transmitting the image data of the read target object as an attachment to an e-mail.

### Printing Process

In the MFP 1, the CPU 52 is enabled to perform a printing process to cause the printer 3 to print an image according to image data on a print medium. For instance, to start the printing process, the user may operate operable key(s) provided on an external device, thereby specifying the image data to be printed and providing an instruction to start the printing process to print the specified image data. In another instance, the user may connect a USB memory with the image data stored therein to the USB connector of the USB I/F 56 and operate operable key(s) provided on the MFP 1, thereby specifying the image data to be printed and providing an instruction to start the printing process to print the specified image data. In response to such user operations, the instruction to start the printing process is input into the CPU 52. In response to receiving the input instruction to start the printing process, the CPU 52 starts the printing process. In addition, when the user operates operable key(s) provided on the MFP 1 to input an instruction to start copying into the CPU 52, the CPU 52 starts the reading process and starts the printing process to print image data generated in the reading process.

In the printing process, the pickup roller 43, the first conveyance rollers 44, the second conveyance rollers 45, the third conveyance rollers 46, and the discharge rollers 47 are driven. When the pickup roller 43 rotates with the circumferential surface thereof in contact with the topmost one of the print media (i.e., the printing sheets P) in the feed tray 34, the topmost print medium (i.e., the topmost printing sheet P) is fed into the curved path 36 of the conveyance path 35. Thereafter, the print medium receives a conveyance force from the first conveyance rollers 44, the second conveyance rollers 45, the third conveyance rollers 46 and the discharge rollers 47 in turn, thereby being conveyed toward the discharge tray 33 along the curved path 36 and straight path 37 of the conveyance path 35.

The printer 3 causes the print head 42 to selectively eject ink from the nozzles while conveying the print medium along the straight path 37, thereby forming an image with ink droplets landing on the print medium. Thus, the image according to the image data is printed on the print medium by the time the print medium completely passes the position facing the print head 42. When the print medium with the image formed thereon according to the image data has finished passing between the discharge rollers 47, the print medium is discharged into a space above the discharge tray 33 and then received by the discharge tray 33.

### Error Notification Timing Determination Process

In the MFP 1, an error that prevents the reading process from being completed may occur during the reading process.

In the MFP 1, while the printing process is in progress, an error may occur that prevents the printing process from being completed. Examples of the error that prevents the printing process from being completed may include, but are not limited to, running out of paper with no printing sheets P in the feed tray 34 and a paper jam in which a printing sheet P is stuck on the conveyance path 35 of the printer 3.

From a time when an error that prevents the reading process or the printing process in progress from being completed has occurred in the MFP 1 until a time when the error is resolved, the MFP 1 is in an error state where the reading process or the printing process is unable to be completed due to the error.

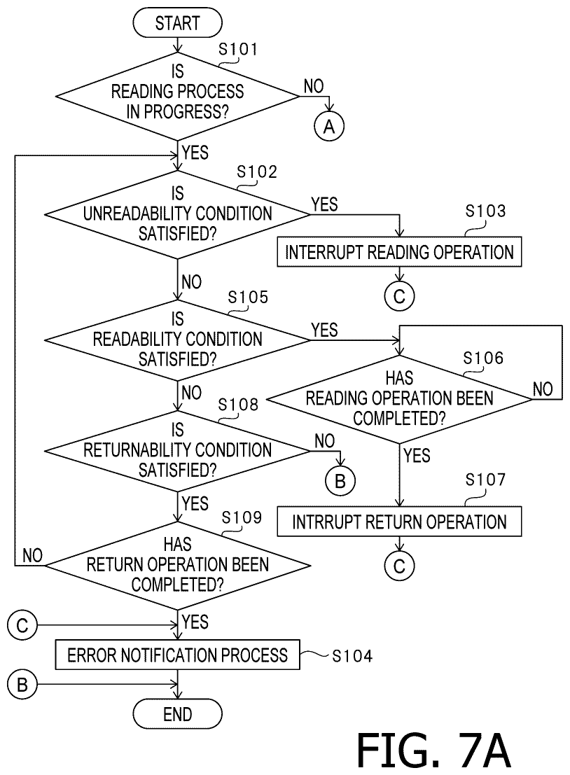

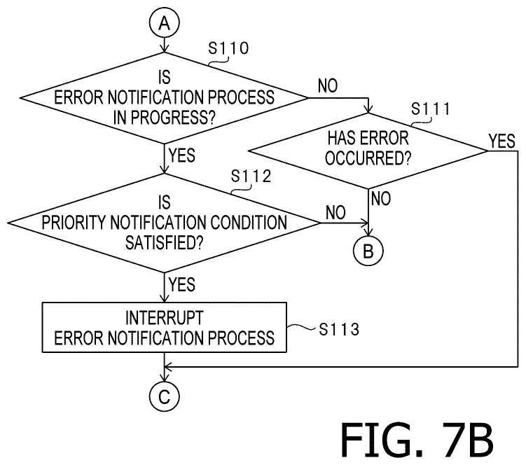

When the MFP 1 is turned on, said turning on the MFP 1 triggers the CPU 52 to perform an error notification timing determination process as shown in FIGS. 7A and 7B.

In the error notification timing determination process, the CPU 52 determines whether the reading process is in progress (S101).

In response to determining that the reading process is in progress (S101: YES), the CPU 52 determines whether an unreadability condition (i.e., a condition that an error that prevents the reading operation from being completed has occurred during the reading operation) is satisfied (S102).

When an error that prevents the reading operation from being completed has occurred during the reading operation, the CPU 52 determines that the unreadability condition is satisfied (S102: YES) and interrupts the reading operation (S103). Then, the CPU 52 performs an error notification process (S104) and causes the reading unit 18 to perform an error notification operation. In the error notification operation, the CPU 52 controls the light source 21 of the reading unit 18 not to be turned on, and controls the moving mechanism 19 to move the reading unit 18 from a position when the reading operation was interrupted to an error notification position, and to stop the reading unit 18 at the error notification position.

When the error state has been resolved by the user, the CPU 52 controls the moving mechanism 19 to move the reading unit 18 from the error notification position to the standby position WP and to stop the reading unit 18 at the standby position WP. The CPU 52 then terminates the error notification process.

The error notification position is a position where the reading unit 18 is within a range of the opening 13 in the left-right directions. In other words, the error notification position is a position where the reading unit 18 is opposed to the transparent plate 14 in a light emission direction in which light is emitted from the light source 21, and the reading unit 18 is visually recognizable by the user through the transparent plate 14. In the illustrative embodiment, the error notification position is settable to different positions in the sub scanning directions depending on what type of error has occurred. For instance, as indicated by double-dash chain lines in FIG. 4, the error notification position is set to an error notification position EIP1 when an error has occurred that prevents the reading operation in the reading process from being completed. In addition, the error notification position is set to an error notification position EIP2 different from the error notification position EIP1, when an error has occurred that allows the reading operation in the reading process to be completed but prevents the return operation from being completed. Further, the error notification position is set to an error notification position EIP3 different from the error notification positions EIP1 and EIP2, when an error has occurred that allows both the reading operation and the return operation in the reading process to be completed but prevents the data transmission operation or the data storage operation from being completed. Furthermore, the error notification position is set to an error notification position EIP4 different from the error notification positions EIP1, EIP2, and EIP3, when an error has occurred that prevents the printing process from being completed.

After the error notification process, the CPU 52 terminates the error notification timing determination process.

When an error that prevents the reading operation from being completed has not occurred during the reading operation, the CPU 52 determines that the unreadability condition is not satisfied (S102: NO). In this case, the CPU 52 determines whether a readability condition (i.e., a condition that an error that prevents the return operation from being completed has occurred during the return operation) is satisfied (S105).

When an error that prevents the return operation from being completed has occurred during the return operation (e.g., when such an error has occurred that the reference position RP is unable to be detected due to a failure of the reading unit 18), the CPU 52 determines that the readability condition is satisfied (S105: YES). Then, the CPU 52 proceeds to S106 and waits until the reading operation is completed (S106: NO). In response to determining that the reading operation has been completed (S106: YES), the CPU 52 interrupts the return operation (S107). Thereafter, the CPU 52 performs the error notification process (S104). Examples of interrupting the return operation while the return operation is in progress may include, but are not limited to, an event in which the return operation is not started even though the time to start the return operation has arrived as the reading operation has been completed.

When an error that prevents the return operation from being completed has not occurred during the return operation, the CPU 52 determines that the readability condition is not satisfied (S105: NO). In this case, the CPU 52 determines whether a returnability condition (i.e., a condition that an error has occurred that prevents the data transmission operation or the data storage operation from being completed or that an error has occurred that prevents the printing process from being completed) is satisfied (S108). In response to determining that the returnability condition is satisfied (S108: YES), the CPU 52 determines whether the return operation has been completed (S109). In response to determining that the return operation has not been completed (S109: NO), the CPU 52 returns to S102, in which the CPU 52 determines whether the unreadability condition is satisfied, and performs the aforementioned processing from S102 onward. In response to determining that the return operation has been completed (S109: YES), the CPU 52 performs the error notification process (S104).

In response to determining that no error has occurred in the MFP 1, i.e., in response to determining that none of the unreadability condition, the readability condition, and the returnability condition is satisfied (S108: NO in addition to S102: NO and S105: NO), the CPU 52 terminates the error notification timing determination process. Then, for instance, after a lapse of a particular time from the termination of the error notification timing determination process, the CPU 52 again performs the error notification timing determination process and determines whether the reading process is in progress (S101).

In response to determining that the reading process is not in progress (S101: NO), the CPU 52 determines whether the error notification process is in progress (S110 in FIG. 7B).

In response to determining that neither the reading process nor the error notification process is in progress (S110: NO in addition to S101: NO), the CPU 52 determines whether an error has occurred in the MFP 1 (S111). In response to determining that no error has occurred in the MFP 1 (S111: NO), the CPU 52 terminates the error notification timing determination process. When an error has occurred in the MFP 1, the CPU 52 determines that an error has occurred (S111: YES). In this case, the CPU 52 performs the error notification process (S104 in FIG. 7A).

In response to determining that the error notification process is in progress (S110: YES in FIG. 7B), the CPU 52 determines whether a priority notification condition is satisfied (S112). The priority notification condition is a condition that an error, which has a higher priority for error notification than the error that has brought the MFP 1 into an error state that is being notified in the error notification process, has occurred during the error notification process. The priority for error notification is set in advance. For instance, an error that prevents the reading process from being completed is set to the highest priority A. An error that prevents the printing process from being completed is set to the second highest priority B after the priority A. An error that allows both the reading operation and the return operation to be completed but prevents the data transmission operation or the data storage operation from being completed is set to the third highest priority C after the priorities A and B. An error that prevents the printing process from continuing due to a lack of ink in the printer 3 is set to the lowest priority D.

In response to determining that the priority notification condition is satisfied (S112: YES), the CPU 52 interrupts the ongoing error notification process (hereinafter, which may be referred to as the “previous error notification process”) (S113) and performs a new error notification process for the error that has occurred during the previous error reporting process (S104 in FIG. 7A). In the new error notification process, the CPU 52 causes the reading unit 18 to perform the error notification operation, thereby causing the reading unit 18 to move from the error notification position before the interruption of the previous error notification process to a new error notification position corresponding to the type of the error that has occurred during the previous error notification process, and to stop at the new error notification position.

If the error state corresponding to the new error notification position has been resolved, and the error state corresponding to the error notification position before the interruption of the previous error notification process has not been resolved, the CPU 52 controls the moving mechanism 19 to move the reading unit 18 from the new error notification position back to the error notification position before the interruption of the previous error notification process. In this case, when the error state corresponding to the error notification position before the interruption of the error notification process has been resolved, the CPU 52 controls the moving mechanism 19 to move the reading unit 18 from the error notification position to the standby position WP and to stop the reading unit 18 at the standby position WP. The CPU 52 then terminates the error notification process. In a case where the error state corresponding to the error notification position before the interruption of the previous error notification process has been resolved at a time when the error state corresponding to the new error notification position has been resolved, the CPU 52 controls the moving mechanism 19 to move the reading unit 18 from the new error notification position to the standby position WP and to stop the reading unit 18 at the standby position WP. The CPU 52 then terminates the error notification process.

In response to determining that the priority notification condition is not satisfied (S112: NO), the CPU 52 terminates the error notification timing determination process without performing the error notification process.

### Operations and Advantageous Effects

As described above, in the reading process, the CPU 52 causes the reading unit 18 to read the read target object placed on the transparent plate 14. In the error notification process, the CPU 52 causes the reading unit 18 to perform the error notification operation to provide a notification that the MFP 1 is in an error state. Thus, the reading unit 18 is used in the reading process and the error notification process.

When an error has occurred while the reading unit 18 is in use, the user has a choice between prioritizing the execution of the error notification process or the continued use of the reading unit 18. Namely, in response to an error occurring during the use of the reading unit 18, there is a choice between interrupting the use of the reading unit 18 and performing the error notification process, and performing the error notification process after completing the use of the reading unit 18. Therefore, the conditions (i.e., the unreadability condition, the readability condition, the returnability condition, and the notification priority condition) for errors that may occur while the reading unit 18 is in use are set in advance. Then, depending on whether these conditions are satisfied, the priority between performing the error notification process and continuing to use the reading unit 18 is determined. This makes it possible to perform the error notification process at the appropriate timing in the case where an error has occurred while the reading unit 18 is in use (i.e., during the reading process or the error notification process).

During the reading process, the reading operation and the return operation are performed. The reading operation is an operation to cause the reading unit 18 to read the read target object while moving the reading unit 18 in one direction (e.g., the rightward direction) of the sub scanning directions, from the reading start position SP to the reading end position EP. The return operation is an operation to move the reading unit 18 in the other direction (e.g., the leftward direction) of the sub scanning directions, from the reading end position EP to the standby position WP and stop the reading unit 18 at the standby position WP, after the reading operation is completed.

When an error that prevents the reading operation from being completed has occurred during the reading operation, the CPU 52 is unable to perform any of the return operation, the data transmission operation, and the data storage operation. Accordingly, in such a case, it is preferable to interrupt the reading operation and provide a notification that the MFP 1 is in an error state. When a notification is provided that the MFP 1 is in an error state, it is expected that the error will be resolved promptly. In addition, it is possible to complete the reading process by resuming and re-performing the reading process after the error is resolved. Therefore, the unreadability condition that an error that prevents the reading operation from being completed has occurred during the reading operation is set. When the unreadability condition is satisfied, the CPU 52 interrupts the reading operation, and perform the error notification process to cause the reading unit 18 to perform the error notification operation.

When an error that prevents the return operation from being completed has occurred during the return operation, the CPU 52 is allowed to perform the data transmission operation or the data storage operation can be performed since the reading operation has been completed, even though the return operation has not been completed. Accordingly, in such a case, it is preferable to interrupt the return operation and provide a notification that the MFP 1 is in an error state. Therefore, the readability condition that an error that prevents the return operation from being completed has occurred during the return operation is set. When the readability condition is satisfied, the CPU 52 interrupts the return operation, and perform the error notification process to cause the reading unit 18 to perform the error notification operation.

When an error has occurred that prevents the data transmission operation or the data storage operation from being completed, or when an error has occurred that prevents the printing process from being completed, it is preferable to provide a notification that the MFP 1 is in an error state after the return operation is completed. During the return operation, the reference position RP is detected, and the standby position WP and the reading start position SP are set based on the reference position RP. Therefore, when the return operation has been completed, it is possible to operate the reading unit 18 with high positional accuracy in the reading process performed after the error is resolved. Therefore, the returnability condition that an error has occurred that prevents the data transmission operation or the data storage operation from being completed, or that an error has occurred that prevents the printing process from being completed is set. Then, when the returnability condition is satisfied, the CPU 52 performs the error notification process after the return operation is completed, thereby causing the reading unit 18 to perform the error notification operation.

In the error notification operation, the reading unit 18 moves from a position when the reading operation was interrupted to an error notification position and stops at the error notification position. The error notification position is settable to different positions in the sub scanning directions depending on what type of error has occurred. For instance, the different positions settable as the error notification position include the first error notification position EIP1, the second error notification position EIP2, the third error notification position EIP3, and the fourth error notification position EIP4. Thereby, in the error notification operation, the reading unit 18 stops at a corresponding one of the error notification positions EIP1, EIP2, EIP3, and EIP4 depending on what type of error has occurred. Thus, it is possible to notify the user of what type of error has occurred in addition to the information that the MFP 1 is in an error state.

In the aforementioned example, the error notification position is settable to the different positions depending on what type of error has occurred. However, in another instance, the error notification position may be set to a fixed position EIP regardless of the type of the error, as indicated by a solid line in FIG. 4.

### Another Example of Error Notification Timing Determination Process

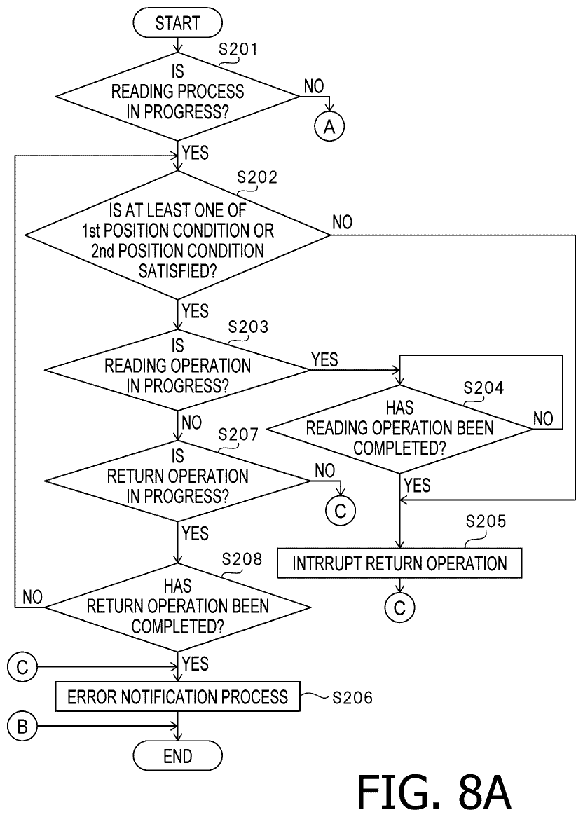

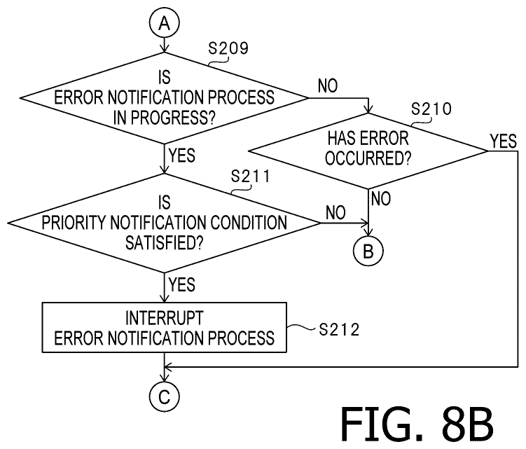

An error notification timing determination process shown in FIGS. 8A and 8B may be performed instead of the error notification timing determination process shown in FIGS. 7A and 7B.

In the error notification timing determination process shown in FIGS. 8A and 8B, the CPU 52 determines whether the reading process is in progress (S201).

In response to determining that the reading process is in progress (S201: YES), the CPU 52 determines whether at least one of a first position condition or a second position condition is satisfied (S202). The first position condition is set to a condition that an error occurrence time position, which is a position of the reading unit 18 during the reading process at a time when an error has occurred, is downstream of the error notification position EIP in the moving direction of the reading unit 18. The error notification position EIP is a position where the reading unit 18 is within a range of the opening 13 in the left-right directions. For instance, the error notification position EIP is set to a single fixed position regardless of the type of the error. The second position condition is set to a condition that a first distance between the error occurrence time position and the reading end position EP or the standby position WP is equal to or less than a second distance between the error occurrence time position and the error notification position EIP.

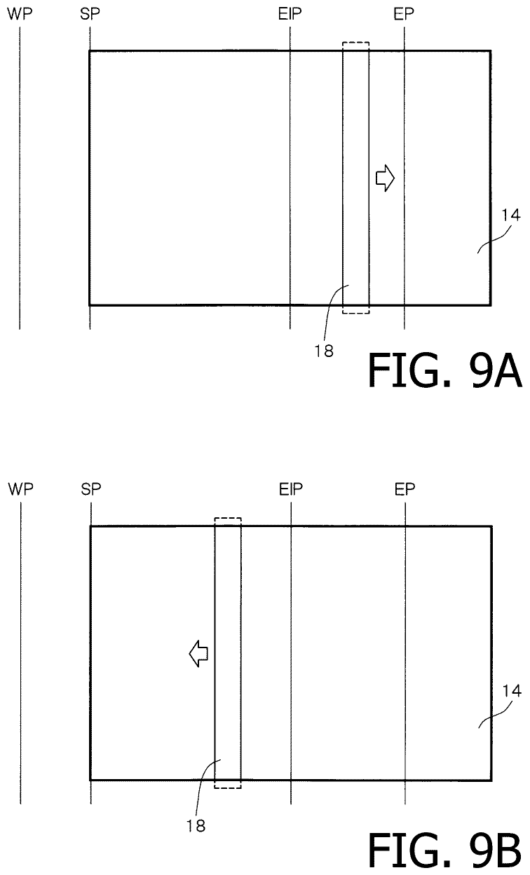

As shown in FIG. 9A, the first position condition is satisfied when the error occurrence time position is downstream of the error notification position EIP in the moving direction of the reading unit 18 (i.e., when the error occurrence time position is between the error notification position EIP and the reading end position EP). In addition, as shown in FIG. 9B, the first position condition is satisfied when an error has occurred during the return operation, and the error occurrence time position is downstream of the error notification position EIP in the moving direction of the reading unit 18 (i.e., when the error occurrence time position is between the error notification position EIP and the standby position WP).

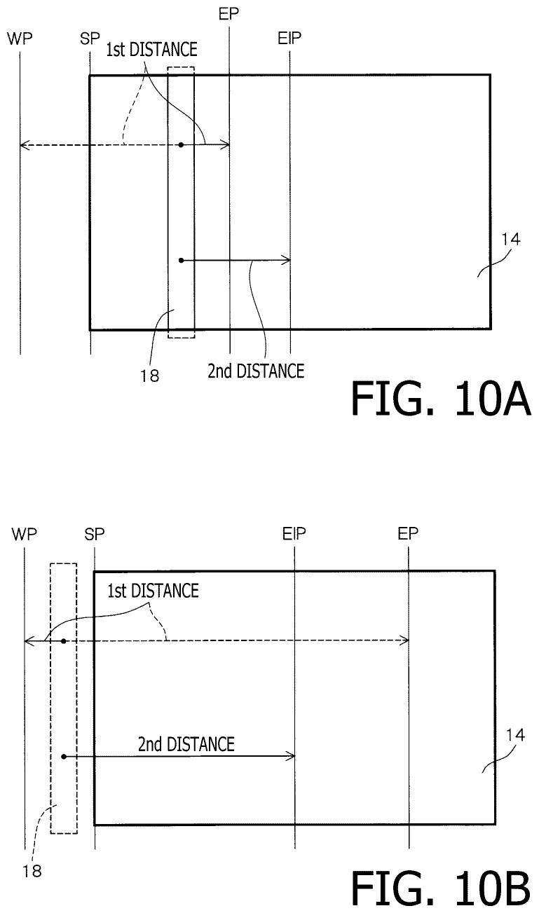

As shown in FIG. 10A, the second position condition is satisfied when the first distance between the error occurrence time position and the reading end position EP is equal to or less than the second distance between the error occurrence time position and the error notification position EIP. The reading end position EP changes depending on the size of the read target object, and may be set closer to the reading start position SP than to the error notification position EIP. In addition, as shown in FIG. 10B, the second position condition is satisfied when the first distance between the error occurrence time position and the standby position WP is equal to or less than the second distance between the error occurrence time position and the error notification position EIP.

In response to determining that at least one of the first position condition or the second position condition is satisfied (S202: YES), the CPU 52 determines whether the reading operation is in progress (S203).

In response to determining that the reading operation is in progress (S203: YES), the CPU 52 determines whether the reading operation has been completed (S204). In response to determining that the reading operation has not been completed (S204: No), the CPU 52 waits (i.e., repeatedly makes the determination in S204) until the reading operation is completed. In response to determining that the reading operation has been completed (S204: Yes), the CPU 52 interrupts the reading process (more specifically, in this case, interrupts the return operation) (S205) and performs the error notification process (S206).

In response to determining that the reading operation is not in progress (S203: NO), the CPU 52 determines whether the return operation is in progress (S207). In response to determining that the return operation is in progress (S207: YES), the CPU 52 determines whether the return operation has been completed (S208). In response to determining that the return operation has not been completed (S208: NO), the CPU 52 returns to S202, in which the CPU 52 determines whether at least one of the first position condition or the second position condition is satisfied, and performs the aforementioned processing from S202 onward. Then, in response to determining that the return operation has been completed (S208: YES), the CPU 52 performs the error notification process (S206).

If neither the reading operation nor the return operation is in progress when an error has occurred, that is, the data transmission operation or the data storage operation is in progress when an error has occurred, the CPU 52 determines that the return operation is not in progress (S207: NO) and performs the error notification process (S206).

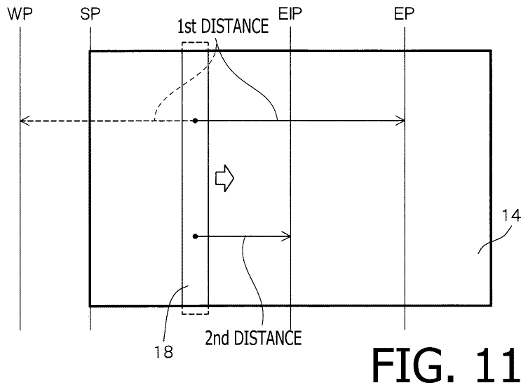

On the other hand, in response to determining that none of the first position condition and the second position condition is satisfied (S202: NO), the CPU 52 interrupts the reading process (S205) and performs the error notification process (S206). None of the first position condition and the second position condition is satisfied when, as shown in FIG. 11, the error occurrence time position is upstream of the error notification position EIP in the moving direction of the reading unit 18, and the first distance between the error occurrence time position and the reading end position EP is greater than the second distance between the error occurrence time position and the error notification position EIP.

In response to determining that the reading process is not in progress (S201: NO), the CPU 52 determines whether the error notification process is in progress (S209 in FIG. 8B).

In response to determining that neither the reading process nor the error notification process is in progress (S209: NO in addition to S201: NO), the CPU 52 determines whether an error has occurred in the MFP 1 (S210). In response to determining that no error has occurred in the MFP 1 (S210: NO), the CPU 52 terminates the error notification timing determination process. When an error has occurred in the MFP 1, the CPU 52 determines that an error has occurred (S210: YES). In this case, the CPU 52 performs the error notification process (S206 in FIG. 8A).

In response to determining that the error notification process is in progress (S209: YES in FIG. 8B), the CPU 52 determines whether the priority notification condition is satisfied (S211). The priority notification condition is a condition that an error, which has a higher priority for error notification than the error that has brought the MFP 1 into an error state that is notified in the error notification process, has occurred during the error notification process. For instance, the priority for error notification is set to be the same as in the case of the error notification timing determination process shown in FIGS. 7A and 7B.

In response to determining that the priority notification condition is satisfied (S211: YES), the CPU 52 interrupts the ongoing error notification process (hereinafter, which may be referred to as the “previous error notification process”) (S212) and performs a new error notification process for the error that has occurred during the previous error notification process (S206 in FIG. 8A). For instance, in the new error notification process, the CPU 52 causes the reading unit 18 to perform an error notification operation, in which the reading unit 18, stopped at the error notification position in the previous error notification process, moves to a new position different from the error notification position and stops at the new position. Thus, since the reading unit 18 is stopped at the new position different from the error notification position, it is possible for the user who has visually recognized the reading unit 18 stopped at the new position to realize that an error, which has a higher priority for error notification than a previous error, has occurred during the previous error notification process for providing a notification about the error state of the MFP 1 due to the previous error.

In substantially the same manner as in the error notification timing determination process shown in FIGS. 7A and 7B, when the error state corresponding to the new position has been resolved, and the error state corresponding to the error notification position before the interruption of the previous error notification process has not been resolved, the CPU 52 controls the moving mechanism 19 to move the reading unit 18 from the new position back to the error notification position before the interruption of the previous error notification process. In this case, when the error state corresponding to the error notification position before the interruption of the previous error notification process has been resolved, the CPU 52 controls the moving mechanism 19 to move the reading unit 18 from the error notification position to the standby position WP and stop the reading unit 18 at the standby position WP. Then, the CPU 52 terminates the error notification process. When the error state corresponding to the error notification position before the interruption of the previous error notification process has been resolved at a time when the error state corresponding to the new position has been resolved, the CPU 52 controls the moving mechanism 19 to move the reading unit 18 from the new position to the standby position WP and stop the reading unit 18 at the standby position WP. Then, the CPU 52 terminates the error notification process.

In response to determining that the priority notification condition is not satisfied (S211: NO), the CPU 52 terminates the error notification timing determination process without executing the error notification process.

### Operations and Advantageous Effects

Consider the case where, in the error notification timing determination process shown in FIGS. 8A and 8B, the error occurrence time position is downstream of the error notification position EIP in the moving direction of the reading unit 18, or the first distance between the error occurrence time position and the reading end position EP is equal to or less than the second distance between the error occurrence time position and the error notification position EIP, when an error has occurred during the reading operation. In this case, after the reading operation is completed, the CPU 52 interrupts the return operation, and performs the error notification process to cause the reading unit 18 to perform the error notification operation. Thereby, it is possible to perform the data transmission operation to transmit the image data obtained in the reading operation to an external device or the data storage operation to store the image data in a USB memory.

Further, consider the case where the error occurrence time position is downstream of the error notification position EIP in the moving direction of the reading unit 18, or the first distance between the error occurrence time position and the reading end position EP is equal to or less than the second distance between the error occurrence time position and the error notification position EIP, when an error has occurred during the return operation. In this case, after the return operation is completed, the CPU 52 performs the error notification process to cause the reading unit 18 to perform the error notification operation. Thereby, during the return operation, the reference position RP is detected, and the standby position WP and the reading start position SP are set based on the reference position RP. Therefore, it is possible to move the reading unit 18 with high positional accuracy in the reading process performed after resolution of the error.

Further, consider the case where the error occurrence time position is upstream of the error notification position EIP in the moving direction of the reading unit 18, and the first distance between the error occurrence time position and the reading end position EP is greater than the second distance between the error occurrence time position and the error notification position EIP, when an error has occurred during the reading process. In this case, the CPU 52 interrupts the reading process, and performs the error notification process to cause the reading unit 18 to perform the error notification operation. Thus, it is expected that the error will be resolved promptly since the CPU 52 causes the reading unit 18 to perform the error notification operation to provide a notification that the MFP 1 is in an error state. In addition, it is possible to complete the reading process by resuming or re-performing the reading process after the error is resolved.

In the present example, the error notification position EIP is set to the single fixed position regardless of the type of the error. However, the error notification position EIP may be set to a plurality of different positions in the sub scanning directions, regardless of the type of the error. In this case, it is preferable that, in the error notification operation, the reading unit 18 is moved to and stopped at the nearest one of the different positions settable as the error notification position EIP from the position of the reading unit 18 at a time when the error notification process was started. This makes it possible to complete the error notification operation in a shorter time, and thus to reduce the time required from the occurrence of an error until a notification is provided that the MFP 1 is in an error state.

In the error notification timing determination process shown in FIGS. 8A and 8B, the error notification position may be set to different positions in the sub scanning directions depending on what type of error has occurred. In this case, in the error notification operation, the reading unit 18 may be moved to and stopped at a corresponding one of the different positions settable as the error notification position, depending on the type of the error.

While aspects of the present disclosure have been described in conjunction with various example structures outlined above and illustrated in the drawings, various alternatives, modifications, variations, improvements, and/or substantial equivalents, whether known or that may be presently unforeseen, may become apparent to those having at least ordinary skill in the art. Accordingly, the example embodiment(s), as set forth above, are intended to be illustrative of the technical concepts according to aspects of the present disclosure, and not limiting the technical concepts. Various changes may be made without departing from the spirit and scope of the technical concepts according to aspects of the present disclosure. Therefore, the disclosure is intended to embrace all known or later developed alternatives, modifications, variations, improvements, and/or substantial equivalents. Some specific examples of potential modifications according to aspects of the present disclosure are provided below.

### Modifications

For instance, the error notification position may be set to different positions in the sub scanning directions depending on what type of error has occurred. In another instance, however, the error notification position may be set to a single fixed position regardless of what type of error has occurred. For instance, in the error notification operation, the reading unit 18 may be moved to and stopped at the error notification position. In another instance, however, in the error notification operation, the light source 21 of the reading unit 18 may be controlled to emit light in different colors depending on what type of error has occurred. Specifically, in this case, when an error in which the reading unit 18 is unable to move due to a failure of the moving mechanism 19 has occurred, the light source 21 of the reading unit 18 may be controlled to emit light in a corresponding one of the different colors depending on the type of the error.

The image reader 2 may include an ADF (“ADF” is an abbreviation for “Automatic Document Feeder”), and may employ, as a reading method therefor, an ADF method for reading the read target object while conveying the read target object by the ADF, in addition to an FB (“FB” is an abbreviation for “Flat Bed”) method for reading the read target object placed on the transparent board 14. The image reader 2 may employ the ADF method as a reading method and may not employ the FB method. In a configuration in which the FB method is not employed, the reading unit 18 is located at a fixed position. Therefore, in such a configuration, the light source 21 of the reading unit 18 may be turned on at the fixed position in the error notification operation.

When an error has occurred during the reading process, a determination may be made as to which is prioritized between performing the error notification process and continuing to use the reading unit 18. When an error has occurred during the error notification process, a determination may not be made as to which is prioritized between performing the error notification process and continuing to use the reading unit 18.

Conversely, when an error has occurred during the error notification process, a determination may be made as to which is prioritized between performing the error notification process and continuing to use the reading unit 18. In addition, when an error has occurred during the reading process, a determination may not be made as to which is prioritized between performing the error notification process and continuing to use the reading unit 18.

The MFP 1 may include a display device configured to display various types of information.

In the aforementioned illustrative embodiment, the CPU 52 performs each of the processes described above. However, the MFP 1 may include a plurality of CPUs configured to perform each of the processes described above in cooperation with each other. In this case, for instance, the image reader 2 and the printer 3 may have respective CPUs.

The image reader 2 may be a stand-alone device.

The following shows examples of associations between elements illustrated in the aforementioned illustrative embodiment(s) and modification(s), and elements claimed according to aspects of the present disclosure. For instance, the MFP 1 may be an example of a “multi-function peripheral” according to aspects of the present disclosure. The image reader 2 may be an example of an “image reader” according to aspects of the present disclosure. The printer 3 may be an example of a “printer” according to aspects of the present disclosure. The reading unit 18 may be an example of a “reading unit” according to aspects of the present disclosure. The light source 21 may be an example of a “light source” according to aspects of the present disclosure. The transparent plate 14 may be an example of a “transparent plate” according to aspects of the present disclosure. The CPU 52 may be included in a “controller” according to aspects of the present disclosure. Further, the memory 53 storing the programs 53a may be included in the “controller” according to aspects of the present disclosure. The CPU 52 may be an example of a “processor” according to aspects of the present disclosure. The memory 53 storing the programs 53a may be an example of a “non-transitory computer-readable storage medium” storing “computer-readable instructions” according to aspects of the present disclosure.

What is claimed is:

1. An image reader comprising:
a transparent plate having a placement surface configured to support a read target object placed thereon;
a reading unit including a light source configured to emit light toward the transparent plate; and
a controller configured to:
perform a reading process to cause the reading unit to read the read target object placed on the placement surface of the transparent plate;
in response to occurrence of an error, perform an error notification process to cause the reading unit to perform an error notification operation; and
depending on one or more occurrence conditions for the error that has occurred while the reading unit is in use, determine whether to perform the error notification process by interrupting the use of the reading unit or after the use of the reading unit is completed.

2. The image reader according to claim 1,
wherein the controller is further configured to perform, in said determining, determining whether to perform the error notification process by interrupting the reading process or after the reading process is completed, depending on the one or more occurrence conditions for the error that has occurred during the reading process.

3. The image reader according to claim 2,
wherein the controller is further configured to, in the reading process, perform:
a reading operation of causing the reading unit to read the read target object while moving the reading unit in a first direction from a reading start position to a reading end position; and
a return operation of causing the reading unit to move in a second direction from the reading end position and stop at a standby position, the second direction being opposite to the first direction.

4. The image reader according to claim 3,
wherein the one or more occurrence conditions include at least one inoperability condition that an error that prevents the reading operation or the return operation from being completed has occurred during the reading process, and
wherein the controller is further configured to perform, in said determining, determining to perform the error notification process by interrupting the reading process, when the at least one inoperability condition is satisfied.

5. The image reader according to claim 4,
wherein the at least one inoperability condition includes an unreadability condition that an error that prevents the reading operation from being completed has occurred during the reading operation, and
wherein the controller is further configured to perform, in said determining, determining to perform the error notification process by interrupting the reading operation, when the unreadability condition is satisfied.

6. The image reader according to claim 4,
wherein the at least one inoperability condition includes a readability condition that an error that prevents the return operation from being completed has occurred during the return operation, and
wherein the controller is further configured to perform, in said determining, determining to perform the error notification process by interrupting the return operation, when the readability condition is satisfied.

7. The image reader according to claim 4,
wherein the controller is further configured to perform, in said determining, determining to perform the error notification process after the return operation is completed, when the at least one inoperability condition is not satisfied.

8. The image reader according to claim 3,
wherein the controller is further configured to perform, as the error notification operation, causing the reading unit to move to and stop at an error notification position in the error notification process.

9. The image reader according to claim 8,
wherein the one or more occurrence conditions include:
a first position condition that an error occurrence time position is downstream of the error notification position in a moving direction of the reading unit, the error occurrence time position being a position of the reading unit during the reading process at a time when the error has occurred; and
a second position condition that a first distance between the error occurrence time position and the reading end position or the standby position is equal to or less than a second distance between the error occurrence time position and the error notification position, and
wherein the controller is further configured to, in said determining, perform:
determining to perform the error notification process by interrupting the return operation after the reading operation is completed, when the error has occurred during the reading operation, and at least one of the first position condition or the second position condition is satisfied; and
determining to perform the error notification process after the return operation is completed, when the error has occurred during the return operation, and at least one of the first position condition or the second position condition is satisfied.

10. The image reader according to claim 9,
wherein the controller is further configured to perform, in said determining, determining to perform the error notification process by interrupting the reading process, when none of the first position condition and the second position condition is satisfied.

11. The image reader according to claim 10,
wherein the error notification position is settable to different positions in the first direction, and
wherein the controller is further configured to perform, in the error notification process performed according to a determination made in said determining, causing the reading unit to move to and stop at a nearest one of the different positions settable as the error notification position from a position of the reading unit at a time when the error notification process was started.

12. The image reader according to claim 1,
wherein the controller is further configured to, in said determining, perform:
depending on one or more occurrence conditions for a new error that has occurred during the error notification process, determining whether to perform a new error notification process for the new error by interrupting the error notification process or after the error notification process is completed.

13. A multi-function peripheral comprising:
an image reader configured to read a read target object;
a printer configured to print an image on a printing medium; and
a controller,
wherein the image reader comprises:
a transparent plate having a placement surface configured to support the read target object placed thereon; and
a reading unit including a light source configured to emit light toward the transparent plate; and
wherein the controller is configured to:
perform a reading process to cause the reading unit to read the read target object placed on the placement surface of the transparent plate;
in response to occurrence of an error, perform an error notification process to cause the reading unit to perform an error notification operation; and
depending on one or more occurrence conditions for the error that has occurred while the reading unit is in use, determine whether to perform the error notification process by interrupting the use of the reading unit or after the use of the reading unit is completed.

14. The multi-function peripheral according to claim 13,
wherein the controller is further configured to perform the error notification process after the reading process is completed, when the error has occurred in the image reader during the reading process.

15. A method implementable on a processor of an image reader comprising a transparent plate and a reading unit, the method comprising:
performing a reading process to cause the reading unit to read a read target object placed on a placement surface of the transparent plate;
in response to occurrence of an error, performing an error notification process to cause the reading unit to perform an error notification operation; and
depending on one or more occurrence conditions for the error that has occurred while the reading unit is in use, determining whether to perform the error notification process by interrupting the use of the reading unit or after the use of the reading unit is completed.
